(19) United States
(12) Patent Application Publication
(10) Pub. No.: US 2024/0125535 A1
(43) Pub. Date: Apr. 18, 2024

(54) IMPROVED COOLING AIR DISTRIBUTION IN AN AUTOMATED GRID-BASED STORAGE AND RETRIEVAL SYSTEM

(71) Applicant: Autostore Technology AS, Nedre Vats (NO)

(72) Inventor: Trond Austrheim, Etne (NO)

(73) Assignee: Autostore Technology AS, Nedre Vats (NO)

(21) Appl. No.: 18/277,923

(22) PCT Filed: Feb. 18, 2022
(86) PCT No.: PCT/EP2022/054079

§ 371 Date: Aug. 18, 2023

(30) Foreign Application Priority Data
Mar. 1, 2021 (NO) 20210275
May 27, 2021 (NO) 20210675

(51) Int. Cl. F25D 13/00; B65G 1/04; F25D 17/06

(52) U.S. Cl. CPC F25D 13/00; B65G 1/0478; F25D 17/06

(57) ABSTRACT

An automated, grid-based storage and retrieval system includes a framework structure and a cooler system. The framework structure includes vertically extending members and a grid of horizontal rails provided at upper ends of said vertical members. The framework structure defines a storage volume disposed below the horizontal rails, and an air release volume disposed below the horizontal rails and above the storage volume. The cooler system is for releasing cooling air into the air release volume. The cooler system includes at least one air deflecting element provided in the air release volume. The at least one air deflecting element extends between vertically extending members. The at least one air deflecting element is arranged to deflect a flow of released cooling air from the cooler system downward to the storage volume. The deflected cooling air is introduced into the storage volume from above and propagates in a vertical direction downward through the storage volume.

The present invention relates to an automated storage and retrieval system for storage and retrieval of containers, in particular to a system for improved distribution of cooling air throughout the automated storage and retrieval system.

### BACKGROUND AND PRIOR ART

FIG. 1 discloses a prior art automated storage and retrieval system 1 with a framework structure 100 and FIGS. 2 and 3 disclose two different prior art container handling vehicles 201, 301 suitable for operating on such a system 1.

The framework structure 100 comprises upright members 102 and horizontal members 103 and a plurality of storage columns 105 arranged in rows between the upright members 102 and the horizontal members 103. In these storage columns storage containers 106, also known as bins, are stacked one on top of one another to form stacks 107. The members 102, 103 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201, 301 are operated to raise storage containers 106 from, and lower storage containers 106 into the storage columns 105, and also to transport the storage containers 106 above the storage columns 105. The rail system 108 comprises a first set of parallel rails 110 arranged to guide movement of the container handling vehicles 201, 301 in a first direction X across the top of the frame structure 100, and a second set of parallel rails 111 arranged perpendicular to the first set of rails 110 to guide movement of the container handling vehicles 201, 301 in a second direction Y which is perpendicular to the first direction X. Containers 106 stored in the columns 105 are accessed by the container handling vehicles through access openings 112 in the rail system 108. The container handling vehicles 201, 301 can move laterally above the storage columns 105, i.e. in a plane which is parallel to the horizontal X-Y plane.

The upright members 102 of the framework structure 100 may be used to guide the storage containers 106 during raising of the containers 106 out from and lowering of the containers 106 into the columns 105. The stacks 107 of containers 106 are typically self-supportive.

As shown in FIGS. 2-3, each prior art container handling vehicle 201, 301 comprises a vehicle body 201a, 301a, and first and second sets of wheels 201b, 301b, 201c, 301c which enable the lateral movement of the container handling vehicles 201, 301 in the X-direction and in the Y-direction, respectively. In FIGS. 2 and 3 two wheels in each set are fully visible. The first set of wheels 201b, 301b is arranged to engage with two adjacent rails of the first set 110 of rails of FIG. 1, and the second set of wheels 201c, 301c is arranged to engage with two adjacent rails of the second set 111 of rails of FIG. 1. At least one of the sets of wheels 201b, 301b, 201c, 301c can be lifted and lowered, so that the first set of wheels 201b, 301b and/or the second set of wheels 201c, 301c can be engaged with the respective set of rails 110, 111 of FIG. 1 at any one time.

With reference to FIGS. 1-3, each prior art container handling vehicle 201, 301 also comprises a lifting device (not shown) for vertical transportation of storage containers 106, raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201, 301 so that the position of the gripping/engaging devices with respect to the vehicle 201, 301 can be adjusted in a third direction Z which is orthogonal the first direction X and the second direction Y. Parts of the gripping device of the container handling vehicle 301 are shown in FIG. 3 indicated with reference number 304. The gripping device of the container handling device 201 is located within the vehicle body 201a in FIG. 2.

Conventionally, and also for the purpose of this application, Z=1 identifies the uppermost layer of storage containers 106, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers 106. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=18, Y=1, Z=6 The container handling vehicles 201, 301 can be said to travel in layer Z=0, and each storage column 105 can be identified by its X and Y coordinates.

The storage volume of the framework structure 100 has often been referred to as a grid, where the possible storage positions within this grid 104 are referred to as storage cells. Each storage column 105 may be identified by a position in an X- and Y-direction, while each storage cell may be identified by a container number in the X-, Y- and Z-direction.

Still with reference to FIGS. 1-3, each prior art container handling vehicle 201, 301 comprises a storage compartment or space for receiving and stowing a storage container 106 when transporting the storage container 106 across the rail system 108. The storage space may comprise a cavity arranged centrally within the vehicle body 201a as is the case for the vehicle 201 shown from above in FIG. 2 and as described in e.g. WO2015/193278A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The central cavity container handling vehicles 201 shown in FIG. 2 may have a footprint that covers an area with dimensions in the X and Y directions which are generally equal to the lateral extent of a storage column 105, e.g. as is described in WO2015/193278A1, the contents of which are incorporated herein by reference. The term ‘lateral’ used herein may mean ‘horizontal’.

Alternatively, the central cavity container handling vehicles 101 may have a footprint which is larger than the lateral area defined by a storage column 105, e.g. as is disclosed in WO2014/090684A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks.

WO2018/146304, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201, 301 to drop off and/or pick up storage containers 106 e.g. so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119, 120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119, 120 for further transportation to an access station. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201, 301 can drop off storage containers 106 to be transported to an access or a transfer station, and the second port column 120 may be a dedicated pick-up port column where the container handling vehicles 201, 301 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1 but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119, 120 and the access station.

If the port columns 119, 120 and the access station are located at different levels, the conveyor system may comprise a lift device with a vertical component for transporting the storage containers 106 vertically between the port column 119, 120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201, 301 is instructed to retrieve the target storage container 106 from its position and transport it to the drop-off port column 119. This operation involves moving the container handling vehicle 201, 301 to a location above the storage column 105 in which the target storage container 106 is positioned, retrieving the storage container 106 from the storage column 105 using the container handling vehicle's 201, 301 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers 106 prior to lifting the target storage container 106 from the storage column 105. This step, which is sometimes referred to as “digging” within the art, may be performed with the same container handling vehicle 201, 301 that is subsequently used for transporting the target storage container 106 to the drop-off port column 119, or with one or a plurality of other cooperating container handling vehicles 201, 301. Alternatively, or in addition, the automated storage and retrieval system 1 may have container handling vehicles 201, 301 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201, 301 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201, 301 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106; and the movement of the container handling vehicles 201, 301 so that a desired storage container 106 can be delivered to the desired location at the desired time without the container handling vehicles 201, 301 colliding with each other, the automated storage and retrieval system 1 comprises a control system which typically is computerized and which typically comprises a database for keeping track of the storage containers 106.

Some of the above systems 1 may be used to store product items which require a certain environment. For example, some types of food require a cool temperature environment (typically temperatures between 1° C.-6° C.), some types of food require an even colder temperature environment (typically temperatures lower than −15° C.), and other types of food require a higher temperature environment (typically temperatures above 10° C.).

In buildings in which such storage systems are located, ventilation systems are typically used to provide the desired environment. However, with the space efficiency obtained by storing the containers in stacks adjacent to each other, less air is available in the storage area for the temperature control of the stored products.

An air purification unit for purifying air of a warehousing system is disclosed in WO2014/079094A1. The air purification unit comprises a central fan and a plurality of filtering devices. JP2000327111A discloses an automatic refrigerating warehouse which includes a warehouse body and a cooler for blowing cooling air into the warehouse body. A number of storage shelves is horizontally arranged in the warehouse body. Cargo can be automatically carried in and out of the shelves using an overhead travelling crane and a stacker crane. Cooling air from the cooler is blown to the lower part of the warehouse body. Introduced cooling air increases in temperature, moves up and is sucked back into the cooler from the upper part of the warehouse body. A unit disclosed in Japanese patent application with publication number JP60-258009A bears certain structural similarities with the warehouse of JP2000327111A.

WO2016/193419 discloses one or more chiller units forming a reservoir of cooled air. Chiller units are positioned above the storage stacks. The cooled air leaves the chiller units and moves between, around and through the storage stacks.

A general problem with the solutions belonging to the prior art is their structural complexity. This problem is additionally accentuated when very large storage spaces need to be cooled.

In view of the above it is desirable to provide an automated storage and retrieval system that solves or at least mitigates one or more of the aforementioned problems related to use of prior art storage and retrieval systems.

### SUMMARY OF THE INVENTION

The present invention is set forth and characterized in the independent claims, while the dependent claims describe other characteristics of the invention.

First aspect of the invention relates to an automated, grid-based storage and retrieval system, said system comprising:
a framework structure comprising vertically extending members and a grid of horizontal rails provided at upper ends of said vertical members, the framework structure defining:
   a storage volume disposed below the horizontal rails, and
   an air release volume disposed below the horizontal rails and above the storage volume,
a cooler system for releasing cooling air into the air release volume, said cooler system comprising:
   at least one air deflecting element provided in the air release volume, said at least one air deflecting element extending between vertically extending members, wherein said at least one air deflecting element is arranged to deflect a flow of released cooling air from the cooler system downward to the storage volume.

By deflecting a flow of released cooling air downward to the storage volume, by means of air deflecting elements positioned in the air release volume, the horizontal rails, i.e. drive tracks, may be protected from exposure to prohibitively cold air. Hence, the temperature in the area surrounding said drive tracks may be kept above a predetermined limit value—typically around 2° C.

The solution according to claim 1 is mechanically simple and may be realized without moving parts. Accordingly, it is relatively easy to install and maintain—a significant advantage in the harsh environment of the cooled storage spaces.

Temperature properties of different sections of the storage system are easily altered, for instance by adjusting the number of the air deflecting elements in the system and/or by adjusting the flow of cooling air.

Second aspect of the invention relates to a method of cooling a storage volume in an automated, grid-based storage and retrieval system, said method comprising:
providing a framework structure comprising vertically extending members and a grid of horizontal rails provided at upper ends of said vertical members,
providing a storage volume disposed below the horizontal rails,
providing an air release volume disposed below the horizontal rails and above the storage volume,
providing at least one air deflecting element in the air release volume,
releasing cooling air into the air release volume, and
deflecting a flow of released cooling air downward by means of at least one air deflecting element.

For the sake of brevity, advantages discussed above in connection with the storage and retrieval system may even be associated with the corresponding method and are not further discussed.

Third aspect of the invention relates to a method of installing a cooler system in an automated, grid-based storage and retrieval system. The method includes:
providing an evaporator unit with a fan for releasing cooling air into an air release volume disposed below horizontal rails and above a storage volume of the storage and retrieval system, and
arranging at least one air deflecting element between two adjacent, vertically extending members in the air release volume.

By virtue of the constructional simplicity of the improved cooler system, retrofitting existing storage systems with a cooler functionality is greatly facilitated.

In all aspects of the invention, the air deflecting elements are fastened to the vertically extending members in any of the manners well known to the person skilled in the art, such as by means of nuts and bolts or by means of rivets.

The relative terms “upper”, “lower”, “below”, “above”, “higher” etc. shall be understood in their normal sense and as seen in a Cartesian coordinate system. When mentioned in relation to a rail system, “upper” or “above” shall be understood as a position closer to the surface rail system (relative to another component), contrary to the terms “lower” or “below” which shall be understood as a position further away from the rail system (relative another component).

### BRIEF DESCRIPTION OF THE DRAWINGS

The following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having a centrally arranged cavity for carrying storage containers therein.

FIG. 3 is a perspective view of a prior art container handling vehicle having a cantilever for carrying storage containers underneath.

FIG. 4a is a perspective view of a part of an automated, grid-based storage and retrieval system according to an embodiment of the present invention.

FIG. 4b is a perspective view of the system of FIG. 4a, also showing grid parts according to an embodiment of the present invention.

FIG. 5 is a close-up showing an evaporator unit and air deflecting elements according to an embodiment of the present invention.

FIG. 6 is a close-up of an air deflecting element according to an embodiment of the present invention.

FIG. 7 is a perspective view showing side ducts according to an embodiment of the present invention.

FIG. 8 is a perspective side view showing baffles according to an embodiment of the present invention.

FIG. 9 is perspective view of a thermal break provided between the vertically extending member and the rails according to an embodiment of the present invention.

FIGS. 10a and 10b are perspective views of a thermal break seen from above respectively from below according to an embodiment of the present invention.

FIG. 11 is a cross-section of a vertically extending member according to an embodiment of the present invention.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

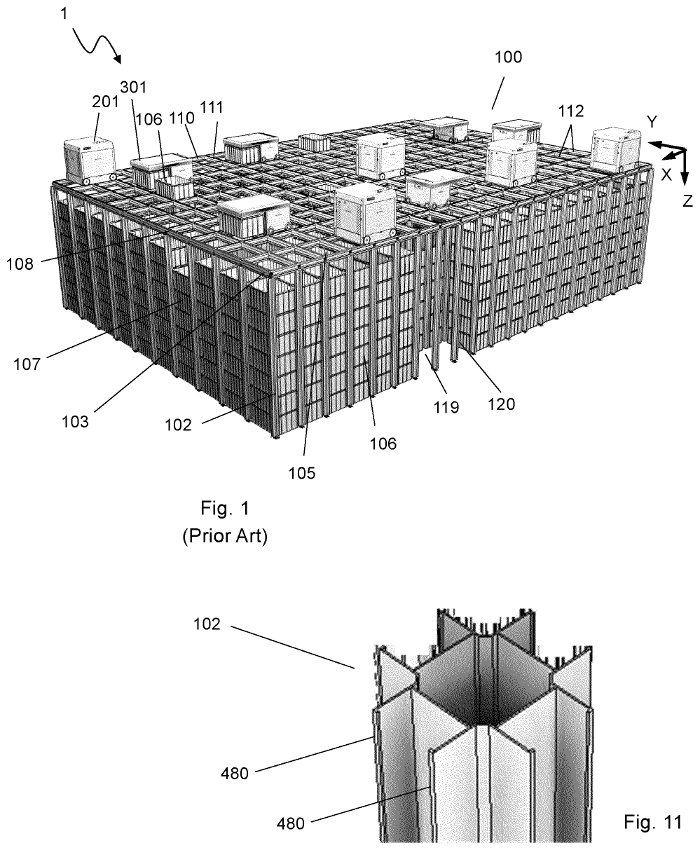

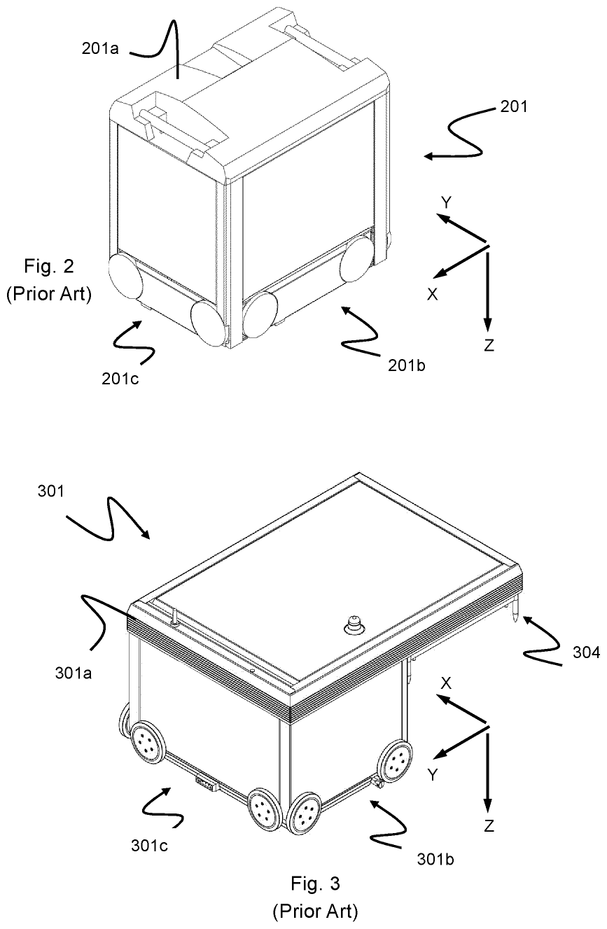

The framework structure of the automated storage and retrieval system is constructed in accordance with the prior art framework structure 100 described above in connection with FIGS. 1-3, i.e. comprising a number of upright members and a number of horizontal members, which are supported by the upright members.

The framework structure can be of any size. In particular, it is understood that the framework structure can be considerably wider and/or longer and/or deeper than disclosed in FIG. 1. For example, the framework structure may have a horizontal extent of more than 700×700 columns and a storage depth of more than twelve containers.

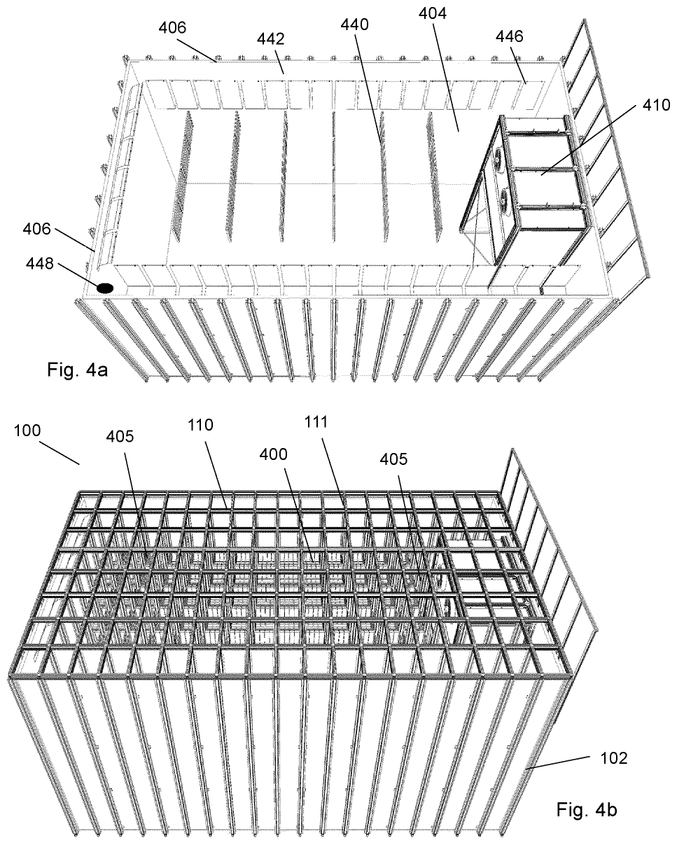

Various embodiments of the automated storage and retrieval system according to the invention will now be discussed in more detail with reference to FIGS. 4-8.

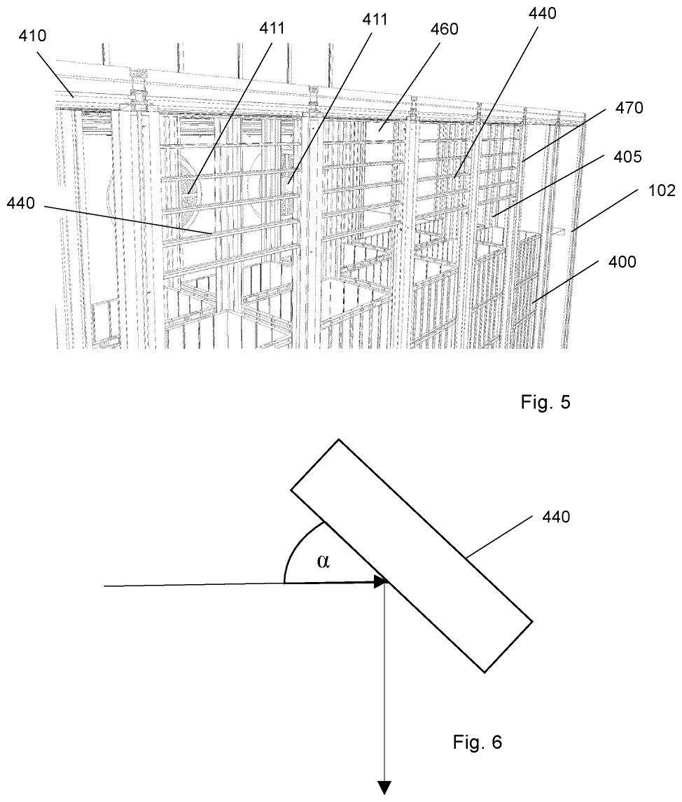

Accordingly, FIG. 4a is a perspective view of an automated, grid-based storage and retrieval system according to an embodiment of the present invention. FIG. 4a shows a cooler system 404 for releasing cooling air into an air release volume 405. An assembly of air deflecting element 440 is also shown. The air deflecting elements 440 are arranged to deflect a flow of released cooling air downward. A laterally delimited volume 406 is also shown. A side duct 442 is provided at the inner periphery of the volume 406. The side duct 442 is delimited by a wall of the laterally delimited volume 406 and by cover plates 446. A distal fan 448 (with reference to the cooler system) is arranged to drive air through the side duct 442 in the general direction of the cooler system 404. Further details of the cooler system 404 will be further discussed in connection with FIGS. 5-8.

FIG. 4b is a perspective view of an automated, grid-based storage and retrieval system of FIG. 4a also showing grid parts shown in FIG. 1. It is shown a framework structure 100 comprising vertically extending members 102 and a grid of horizontal rails 110, 111 provided at upper ends of said vertical members 102. The framework structure 100 defines a storage volume 400 disposed below the horizontal rails 110, 111. An air release volume 405 for receiving cooling air is disposed below the horizontal rails 110 and above the storage volume 400.

FIG. 5 is a close-up showing an evaporator unit and air deflecting elements according to an embodiment of the present invention. The evaporator unit 410 comprising an evaporator and fans 411. The fans 411 are arranged to provide cooling air to the air release volume 405. It is further shown a storage volume 400 disposed below the horizontal rails 110. An air release volume 405 is disposed below the horizontal rails 110 and above the storage volume 400. Air deflecting elements 440 is provided in the air release volume 405, said air deflecting element 440 extending between vertically extending members 102. The air deflecting elements 440 are so arranged that they deflect a flow of released cooling air generated in the evaporator unit 410 downward to the storage volume 400. As seen, the air deflecting elements 440 bridge adjacent vertical members 102. A subset 460 of air deflecting elements 440 consists of all air deflecting elements bridging two adjacent vertical members 102. In a related context, a set 470 of air deflecting elements 440 comprises a plurality of successively arranged subsets of air deflecting elements extending in the same plane.

FIG. 6 is a close-up of an air deflecting element 440 according to an embodiment of the present invention. As shown, an air deflecting surface of the at least one air deflecting element 440 is flat. An angle of attack α between the air deflecting surface of the at least one air deflecting element 440 and the flow direction of the released cooling air is acute. In an alternative embodiment (not shown), an air deflecting element could be an airfoil.

In an embodiment (not shown), the air deflecting element 440 is provided with vibration dampening means for reducing wear on the elements 440.

In yet another embodiment, the air deflecting element 440 is rotatable about its longitudinal axis. A rotational position of the air deflecting elements (440) of the most proximal set 470 of air deflecting elements 440 could be a function of a velocity profile of the released cooling air. In another, related embodiment, a rotational position of the air deflecting elements 440 of a set 470 of air deflecting elements is a function of a rotational position of the air deflecting elements of a preceding set 470 of air deflecting elements 440. Here, two air deflecting elements 440 of the subset of air deflecting elements could have different rotational positions.

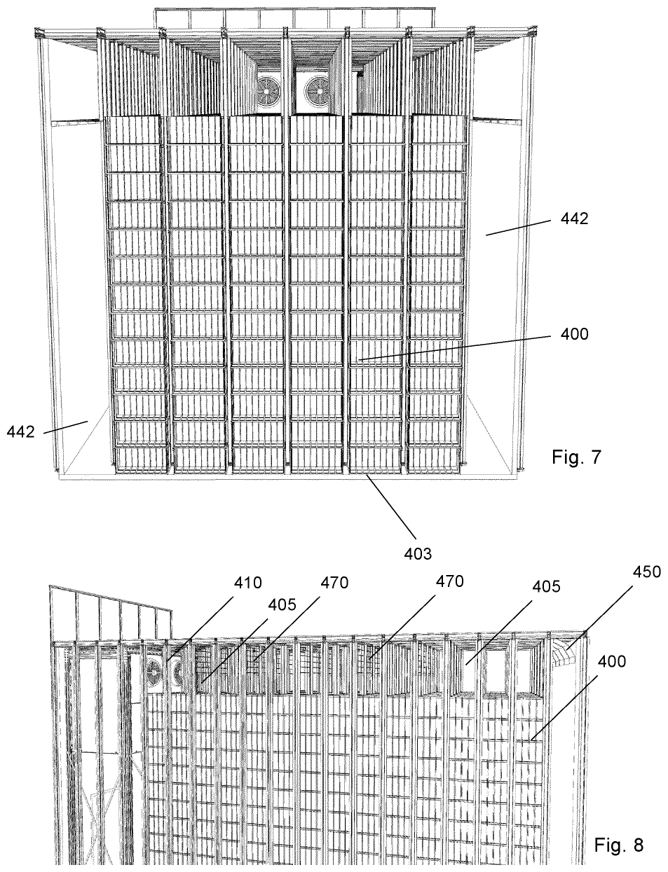

FIG. 7 is a perspective view showing air ducts according to an embodiment of the present invention. Also, an air channel 403 for improving cooling air circulation throughout the system is provided below said storage volume 400.

FIG. 8 is a perspective side view showing baffles according to an embodiment of the present invention. The baffles 450 are oppositely arranged with respect to an evaporator unit 410 and are being positioned exterior to the storage volume 400. The baffles 450 deflect released cooling air downward. As seen, an air deflecting surface of the at least one baffle 450 is curved. Still with reference to FIG. 8, in one embodiment the cooler system comprises sets 470 of air deflecting elements 440 only in an upper section of the air release volume 405. In another, related embodiment, the cooler system 404 comprises sets 470 of air deflecting elements 440 only in a proximal section of the air release volume 405.

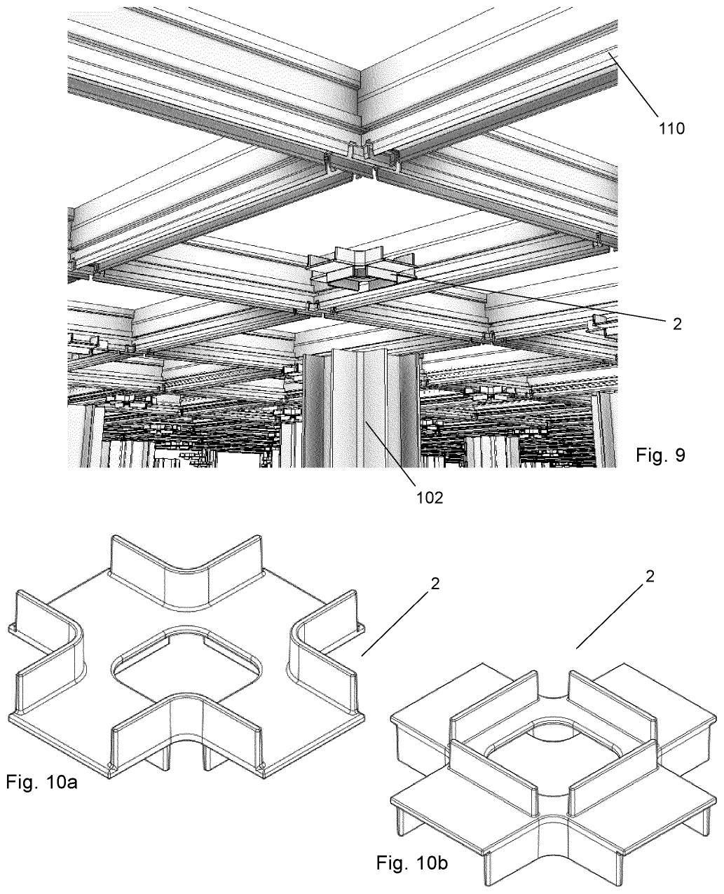

FIG. 9 shows a thermal break 2 associated with the vertically extending member 102 provided immediately below said thermal break 2. As seen, the thermal break is provided below horizontal rails 110. Its purpose is to thermally isolate said rails 110. The vertically extending member 102 may be made in an aluminium alloy and the thermal break 2 may comprise a material having a thermal conductivity lower than 20 W/mK. The thermal conductivity should be as low as possible and may preferably be lower than 1 W/mK. Examples of suitable thermal break materials are synthetic polymers of sufficient strength, such as various types of polyvinyl chloride (PVC), high-density polyethylene (HDPE), polypropylene (PP) and acrylonitrile-butadiene-styrene (ABS). Other thermal break materials, such as various types of wood, may also be used.

The thermal conductivity of a synthetic polymer may be measured according to any of the suitable methods according to ISO 22007-1:2017 or by use of differential scanning calorimetry (DSC) (https://www.mt.com/hk/en/home/supportive_content/matchar_apps/MatChar_UC226.html). The thermal conductivity of wood may be measured according to ASTM 5334.

It is noted that all synthetic polymers and wood will have a thermal conductivity significantly lower than the thermal conductivity of an aluminium alloy. FIGS. 10a and 10b are perspective views of a thermal break of FIG. 9 seen from above respectively from below.

FIG. 11 is a cross-section of a vertically extending member 102 according to an embodiment of the present invention. As seen, the member 102 is hollow with a quadrangular cross-section. Further, the member 102 is provided with a number of flanges 480. More specifically, each side of the quadrangle is associated with two, mutually parallel flanges extending in a plane perpendicular to the plane of the side of the quadrangle. In one embodiment, the width of the air deflecting element (not shown in FIG. 11) doesn't exceed distance between two adjacent, mutually parallel flanges 480. In this way, the air deflecting element, regardless of its rotational position, doesn't interfere with the storage bin during its vertical movement in the storage column (105; visible in FIG. 1).

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 Automated storage and retrieval system
2 Thermal break
100 Framework structure
102 Upright members of framework structure
103 Horizontal members of framework structure
104 Storage grid
105 Storage column
106 Storage container
107 Stack
108 Rail system
110 Horizontal rails in first direction (X)
111 Horizontal rails in second direction (Y)
112 Access opening
119 First port column
120 Second port column
201 Prior art storage container vehicle
201a Vehicle body of the storage container vehicle 201
201b Drive means/wheel arrangement, first direction (X)
201c Drive means/wheel arrangement, second direction (Y)
301 Prior art cantilever storage container vehicle
301a Vehicle body of the storage container vehicle 301
301b Drive means in first direction (X)
301c Drive means in second direction (Y)
400 Storage volume
403 Air channel
404 Cooler system
405 Air release volume
406 Enclosed volume
410 Evaporator unit
411 Evaporator fan
440 Air deflecting element
442 Side duct
446 Cover plate
448 Distal fan
450 Baffle
460 Subset of air deflecting elements
470 Set of air deflecting elements
480 Flange of the vertically extending member
X First direction
Y Second direction
Z Third direction
α Angle of attack

1. An automated, grid-based storage and retrieval system, said system comprising:
a framework structure comprising vertically extending members and a grid of horizontal rails provided at upper ends of said vertical members, the framework structure defining:
a storage volume disposed below the horizontal rails, and
an air release volume disposed below the horizontal rails and above the storage volume,
a cooler system for releasing cooling air into the air release volume, said cooler system comprising:
at least one air deflecting element provided in the air release volume, said at least one air deflecting element extending between vertically extending members, wherein said at least one air deflecting element is arranged to deflect a flow of released cooling air from the cooler system downward to the storage volume,
wherein the deflected cooling air is introduced into the storage volume from above and propagates in a vertical direction downward through the storage volume.

2. System according to claim 1, said system being provided within a laterally delimited volume, wherein at least one side duct is provided at the inner periphery of said volume,
wherein said at least one side duct is delimited by a wall of the laterally delimited volume and by cover plates.

3. (canceled)

4. The system according to claim 2, wherein a distal fan is arranged to drive air through the side duct.

5. The system according to claim 1, wherein an air channel is provided below said storage volume.

6.-7. (canceled)

8. The system according to claim 1, wherein an air deflecting surface of the at least one air deflecting element is flat.

9. The system according to claim 8, wherein an angle of attack (α) between the air deflecting surface of the at least one air deflecting element and the flow direction of the released cooling air is acute.

10.-13. (canceled)

14. The system according to claim 1, wherein the at least one air deflecting element is rotatable about its longitudinal axis.

15. The system according to claim 1, wherein the at least one air deflecting element is provided with vibration dampening means.

16. The system according to claim 1, wherein the at least one air deflecting element bridges adjacent vertical members.

17. The system according to claim 1, wherein a subset of air deflecting elements consists of all air deflecting elements bridging adjacent vertical members.

18. The system according to claim 17, wherein the cooler system comprises at least one set of air deflecting elements comprising a plurality of successively arranged subsets of air deflecting elements.

19. The system according to claim 18, wherein a rotational position of the air deflecting elements of the most proximal set of air deflecting elements is a function of a velocity profile of the released cooling air.

20. The system according to claim 18, wherein a rotational position of the air deflecting elements of a set of air deflecting elements is a function of a rotational position of the air deflecting elements of a preceding set of air deflecting elements.

21.-26. (canceled)

27. The system according to claim 1, wherein at least one side of the vertically extending member is associated with two, mutually parallel flanges extending in a plane perpendicular to the plane of the side of the vertically extending member, wherein the width of the air deflecting element (440) does not exceed distance between said two, mutually parallel flanges,
wherein the vertically extending member has quadrangular cross-section and each corner of the vertically extending member is associated with two, mutually perpendicular flanges.

28. (canceled)

29. A method of cooling a storage volume in an automated, grid-based storage and retrieval system, said method comprising:
providing a framework structure comprising vertically extending members and a grid of horizontal rails provided at upper ends of said vertical members,
providing a storage volume disposed below the horizontal rails,
providing an air release volume disposed below the horizontal rails and above the storage volume,
providing at least one air deflecting element in the air release volume, releasing cooling air into the air release volume,
deflecting a flow of released cooling air downward by means of at least one air deflecting element, and
wherein the deflected cooling air is introduced into the storage volume from above and propagates in a vertical direction downward through the storage volume.

30.-31. (canceled)
